(19) United States
(12) Patent Application Publication
(10) Pub. No.: US 2013/0285450 A1
(43) Pub. Date: Oct. 31, 2013

(54) PRINTED CIRCUIT BOARD

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: SHI-PIAO LUO, Shenzhen (CN); CHIA-NAN PAI, Tu-Cheng (TW); SHOU-KUO HSU, Tu-Cheng (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/734,939

(22) Filed: Jan. 5, 2013

(30) Foreign Application Priority Data
Apr. 28, 2012 (CN) 201210128687.8

(51) Int. Cl. H02J 1/00

(52) U.S. Cl. CPC H02J 1/00
USPC 307/31

(57) ABSTRACT

A printer circuit board (PCB) includes a voltage regulator module (VRM) and a body. The VRM supplies power to a first load and a second load. A decoupling circuit is set on one side of the first load, and the decoupling circuit is electronically connected to the first load. The body includes a multi-layer circuit board. The VRM, the first load, and the second load are positioned on one layer of the circuit board, where the VRM is electronically connected to the first load, but the VRM and the first load are electronically disconnected with the second load. The VRM, the first load, and the second load two are positioned on two other layers of the circuit board, where the first load is electronically connected to the second load, but the first load and the second load are electronically disconnected to the VRM.

### BACKGROUND

1. Technical Field

The present disclosure is related to a printed circuit board.

2. Description of Related Art

When load-pull frequency is greater than switching frequency of a voltage regulator module (VRM), in the VRM, the VRM cannot respond a voltage requirement of the load immediately. A corresponding decoupling circuit may be located between the VRM and the load to supply a stable voltage to the load.

FIG. 2 is a VRM 100 positioned on a printed circuit board (PCB) 200. The

VRM 100 supplies power to a plurality of loads, for example a first load that is a dual-inline-memory-module (DIMM) 101, and a second load that is a central processing unit (CPU) 102.

A decoupling circuit 103 is positioned on one side of the DIMM 101. The DIMM 101 is electronically connected to the decoupling circuit 103. The PCB 200 includes a first layer 201, a second layer 202, a third layer 203, a fourth layer 204, a fifth layer 205, a sixth layer 206, a seventh layer 207, and an eighth layer 208. The VRM 100, the DIMM 101, and the CPU 102 are positioned on the first layer 201 and the fifth layer 205, where the VRM 100, the DIMM 101, and the CPU 102 are electronically disconnected from each other. The VRM 100, the DIMM 101, and the CPU 102 are positioned on the second layer 202 and the seventh layer 207, where the DIMM 101 is electronically connected to the CPU 102, but the DIMM 101 and the CPU 102 are electronically disconnected from the VRM 100. The VRM 100 is positioned on the third layer 203 and the sixth layer 206. The VRM 100, the DIMM 101, and the CPU 102 are positioned on the fourth layer 204, where the VRM 100, the DIMM 101, and the CPU 102 are electronically connected to each other. The VRM 100 and the DIMM 101 are positioned on the eighth layer 208, where the VRM 100 is electronically disconnected from the DIMM 101.

According to the wiring of each layer of the PCB 200, when the VRM 100 supplies power to the DIMM 101, a voltage output from the VRM 100 is transported through the fourth layer 204 to the decoupling circuit 103. The voltage output from the VRM 100 is processed by the decoupling circuit 103 and then is output to the DIMM 101. When the VRM 100 supplies power to the CPU 102, the voltage output from the VRM 100 directly outputs through the fourth layer 204 to the CPU 102. A decoupling circuit is not positioned between the VRM 100 and the CPU 102. When pulling-load of the CPU 102 is quick, the VRM 100 cannot respond immediately. Then the input voltage of the load equaling to the CPU 102 is pulled low (e.g., 0V) instantaneously to let the CPU 102 work unsteadily or crash.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is a schematic view of a printed circuit board according to an embodiment of the present disclosure.

FIG. 2 is a schematic view of a printed circuit board of related art.

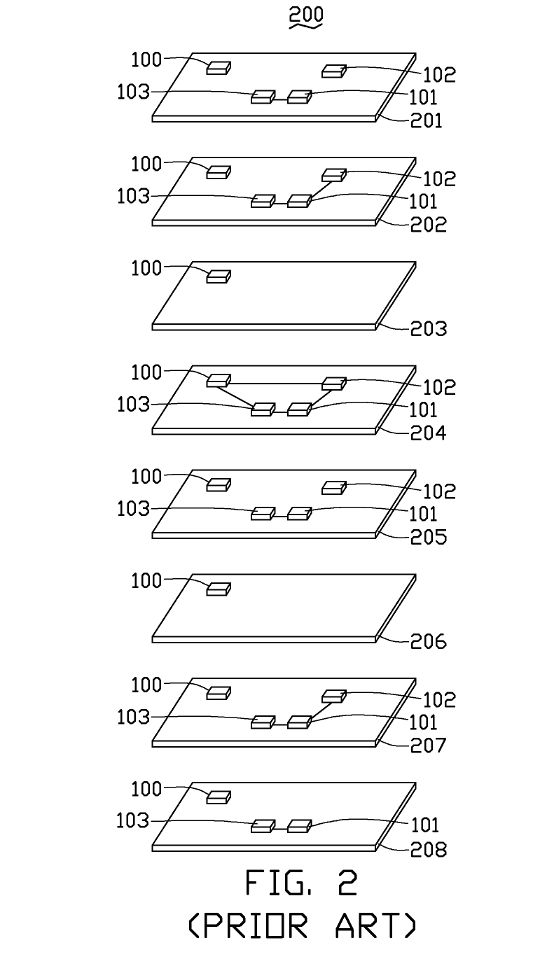

### DETAILED DESCRIPTION

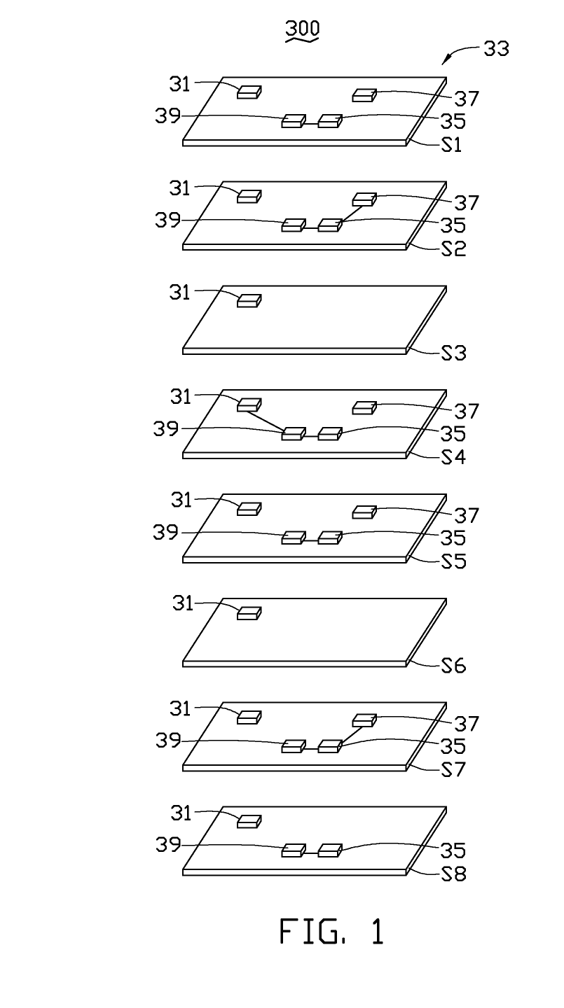

FIG. 1 is an embodiment of the present disclosure relative to a printed circuit board (PCB) 300. The PCB 300 includes a voltage regulator module (VRM) 31 and a body 33.

The VRM 31 is set on the body 33, and supplies power to a plurality of loads, for example a first load, a dual-inline-memory-modules (DIMM), and a second load, a central processing unit (CPU) 37. A decoupling circuit 39 is positioned on one side of the DIMM 35. The DIMM 35 is electronically connected to the decoupling circuit 39.

In the embodiment, the body 35 is a PCB 300 comprising eight layers. The PCB 300 includes a first layer S1, a second layer S2, a third layer S3, a fourth layer S4, a fifth layer S5, a sixth layer S6, a seventh layer S7, and a eighth layer S8. The VRM 31, the DIMM 35, and the CPU 37 are positioned on the first layer S1, where the VRM 31, the DIMM 35, and the CPU 37 are electronically disconnected from each other. The VRM 31, the DIMM 35, and the CPU 37 are positioned on the second layer S2, where the DIMM 35 is electronically connected to the CPU 37, but the DIMM 35 and the CPU 37 are electronically disconnected from the VRM 31. The VRM 31 is positioned on the third layer S3. The VRM 31, the DIMM 35, and the CPU 37 are positioned on the fourth layer S4, where the VRM 31 is electronically connected to the DIMM 35, but the VRM 31 and the DIMM 35 are electronically disconnected from the CPU 37. The VRM 31, the DIMM 35, and the CPU 37 are positioned on the fifth layer S5, where the VRM 31, the DIMM 35, and the CPU 37 are electronically disconnected from each other. The VRM 31 is positioned on the sixth layer S6. The VRM 31, the DIMM 35, and the CPU 37 are positioned on the seventh layer S7, where the DIMM 35 is electronically connected to the CPU 37, but the DIMM 35 and the CPU 37 are electronically disconnected from the VRM 31. The VRM 31 and the DIMM 35 are positioned on the eighth layer S8, where the VRM 31 is electronically disconnected from the DIMM 35.

The following explains the working principle of offering a stable voltage to the PCB 300 of the embodiment in detail.

When the VRM 31 supplies power to the DIMM 35, the voltage output from the VRM 31 is transmitted to the DIMM 35 through the decoupling circuit 39 of the fourth layer S4. When the VRM 31 supplies power to the CPU 37, the voltage output from the VRM 31 is transmitted to the DIMM 35 through the decoupling circuit 39 of the fourth layer S4 at first. And then the voltage is transported to the CPU 37 through the DIMM 35 of the second layer S2 or the seventh layer S7. The VRM 31 supplies power to the CPU 37 by the following path: the voltage output from the VRM 31→the decoupling circuit 39 of the fourth layer S4→the DIMM 35 of the fourth layer S4→the CPU 37 of the second layer S2 or the seventh layer S7. When the load of the CPU 37 pulls quickly, the decoupling circuit 39 responds the voltage immediately, outputting a stable voltage to the CPU 37. The CPU 37 can be prevented from crashing, and the stability of the CPU 37 is raised.

Absolutely, the PCB 200 does not need to set a corresponding decoupling circuit. The path of the VRM 31 supplying power to the CPU 37 is changed because the CPU 37 of the fourth layer S4 is electronically disconnected from the DIMM 35 and the VRM 31 of the fourth layer S4. The DIMM 35 and the CPU 37 use the same decoupling circuit 39. The present disclosure lowers the cost of the production of the PCB 300, and raises the stability for supplying power of the VRM 31.

It is to be further understood that even though numerous characteristics and advantages of the present embodiments have been set forth in the foregoing description, together with details of structures and functions of various embodiments, the disclosure is illustrative only, and changes may be made in detail, especially in matters of arrangement of parts within the principles of the present invention to the full extent indicated by the broad general meaning of the terms in which the appended claims are expressed.

What is claimed is:

1. A printed circuit board (PCB), comprising:
a voltage regulator module (VRM) supplying power to a first load and a second load;
a decoupling circuit set on one side of the first load and electronically connected to the first load; and
a body comprising a plurality of layers, wherein the VRM, the first load, and the second load are positioned on one layer of the body, and the VRM is electronically connected to the first load, the VRM and the first load both electronically disconnected from the second load, where the VRM, the first load, and the second load are positioned on two other layers of the body; the first load is electronically connected to the second load, and the first load and the second load both electronically disconnected from the VRM.

2. The PCB of claim 1, wherein when the VRM supplies power to the first load, the voltage outputted from the VRM is transmitted to the first load through the decoupling circuit of the one layer of the body.

3. The PCB of claim 1, wherein when the VRM supplies power to the second load, the voltage outputted from the VRM is transmitted to the first load through the one layer of the body, and transmitted through the first load of the two layers of the body to the second load.

4. The PCB of claim 1, wherein the body further comprises the VRM, the first load, and the second load positioned on a layer of the body, and the VRM, the first load, and the second load electronically disconnected from each other.

5. The PCB of claim 1, wherein the body further comprises the VRM, the first load, and the second load positioned on two layers of the body, and the VRM, the first load, and the second load electronically disconnected from each other.

6. The PCB of claim 1, wherein the body further comprises only the VRM positioned on a layer of the body.

7. The PCB of claim 1, wherein the body further comprises only the VRM positioned on two layers of the body.

8. The PCB of claim 1 of the body, wherein the body further comprises the VRM and the first load positioned on a layer of the body, and the VRM electronically disconnected from the first load.

9. A printed circuit board (PCB) comprising:
a VRM supplying power to a first load and a second load;
a decoupling circuit set on one side of the first load and connected to the first load; and
a body comprising a plurality of layers, wherein the VRM, the first load, and the second load are positioned on a fourth layer of the body, where the VRM is electronically connected to the first load, but the VRM and the first load are electronically disconnected from the second load, and the VRM, the first load, and the second load are positioned on a second layer and a seventh layer of the body, where the first load is electronically connected to the second load, but the first load and the second load are electronically disconnected from the VRM.

10. The PCB of claim 9, wherein when the VRM supplies power to the first load, the voltage outputted from the VRM is transmitted to the first load through the decoupling circuit of fourth layer of the body.

11. The PCB of claim 9, wherein when the VRM supplies power to the second load, the voltage outputted from the VRM is transmitted to the first load through the fourth layer of the body, and is transmitted to the second load through the first load of the second layer and the seventh layer of the body.

12. The PCB of claim 9, wherein the body further comprises the VRM, the first load, and the second load positioned on a first layer and a fifth layer, where the VRM, the first load, and the second load electronically disconnected from each other.

13. The PCB of claim 9, wherein the body further comprises only the VRM positioned on a third layer and a sixth layer.

14. The PCB of claim 9, wherein the body further comprises the VRM and the first load positioned on an eighth layer, where the VRM electronically disconnected from the first load.
